(19) United States
(12) Patent Application Publication
(10) Pub. No.: US 2022/0267096 A1
(43) Pub. Date: Aug. 25, 2022

(54) WAREHOUSE INVENTORY SYSTEM

(71) Applicant: DELTA DRONE, Dardilly (FR)

(72) Inventors: Philippe BARANGER, La Haye Fouassière (FR); Pierre BLOUET, Nantes (FR)

(21) Appl. No.: 17/628,446

(22) PCT Filed: Jul. 13, 2020
(86) PCT No.: PCT/FR2020/051262

§ 371 Date: Jan. 19, 2022

(30) Foreign Application Priority Data
Jul. 19, 2019 (FR) 1908257

(51) Int. Cl. B65G 1/137; B65G 1/06; G05D 1/02; G05D 1/00

(52) U.S. Cl. CPC B65G 1/1378; B65G 1/1371; B65G 1/065; G05D 1/0246; G05D 1/0088; B65G 2203/041; G05D 2201/0216

(57) ABSTRACT

A warehouse inventory system includes an autonomous robotic device configured to move autonomously in aisles of a storage area of the warehouse and along the shelves arranged in the storage area; a support device integral in movement with the autonomous robotic device; a mast which is supported by the support device and which is equipped with image capturing devices configured to capture images of the objects stored on the shelves during the displacements of the autonomous robotic device along the shelves arranged in the storage area; and a stabilization device configured to vertically stabilize the mast during the displacements of the autonomous robotic device, the stabilization device including a drone connected to the mast.

### CROSS REFERENCE TO RELATED APPLICATIONS

This application is a National Stage of PCT Application No. PCT/FR2020/051262 filed on Jul. 13, 2020, which claims priority to French Patent Application No. 19/08257 filed on Jul. 19, 2019, the contents each of which are incorporated herein by reference thereto.

### TECHNICAL FIELD

The present invention concerns a warehouse inventory system for carrying out an inventory of objects stored on shelves arranged in a storage area of a warehouse.

### BACKGROUND

Such a warehouse inventory system includes, in a known manner:
an autonomous robotic device configured to autonomously move in the aisles of the storage area of the warehouse and along the shelves arranged in the storage area,
a support device integral in movement with the autonomous robotic device, and
a mast which is supported by the support device and which is equipped with image capturing devices configured to capture images of the objects stored on the shelves during the displacements of the autonomous robotic device along the shelves arranged in the storage area.

When such a warehouse inventory system is intended to carry out an inventory of objects stored on high shelves, it is necessary to use a large mast. This mast must be stable enough to guarantee the quality of the image capture and to guarantee the position of the image capture in space with respect to the frame of reference of the warehouse. The inventory system is then equipped with a stabilization device configured to vertically stabilize the mast during the displacements of the autonomous robotic device.

Nonetheless, a mast that is completely integral (embedded connection) with the support device of the warehouse inventory system requires a large-sized and heavy-weight support device in order to avoid any tilting of the mast, for example during a sudden stop of the autonomous robotic device, and requires the presence of a complex guying system, as a device for stiffening the mast.

In addition, in this configuration (namely a mast in embedded connection with the support device securely moving with the autonomous robotic device), the irregularities of the floor will transmit parasitic movements to the mast, which has a direct impact on both the quality of the images but also the accuracy of the position of the image captures.

Furthermore, the use of a bulky support device does not enable the autonomous robotic device to easily circulate in narrow aisles of the warehouse, and the presence of a complex guying system increases the costs of the inventory system and complicates the assembly of the latter. In addition, a mast in an embedded connection with the support device securely moving with the autonomous robotic device reduces the quality of the images captures and the accuracy of the position of the image captures.

### BRIEF SUMMARY

The present invention aims at overcoming all or part of these drawbacks.

The technical problem underlying the invention therefore consists in providing a warehouse inventory system which has a simple and economical structure, while allowing easily carrying out inventories in warehouses with narrow aisles.

To this end, the present invention relates to a warehouse inventory system for carrying out an inventory of objects stored on shelves arranged in a storage area of the warehouse, the warehouse inventory system including:
an autonomous robotic device configured to move autonomously in the aisles of the storage area of the warehouse and along the shelves arranged in the storage area,
a support device integral in movement with the autonomous robotic device,
a mast which is supported by the support device and which is equipped with image capturing devices configured to capture images of the objects stored on the shelves during the displacements of the autonomous robotic device along the shelves arranged in the storage area, the mast being connected to the support device by an articulation with at least two degrees of freedom,
a stabilization device configured to vertically stabilize the mast during the displacements of the autonomous robotic device, the stabilization device including a drone connected to the mast, and for example fastened to the mast.

Such a configuration of the warehouse inventory system, and in particular the presence of a stabilization device equipped with a drone, allows significantly reducing the size and the weight of the support device which supports the mast, allows getting rid of a guying system to vertically stiffen the mast, allows increasing the quality of the image captures as well as the accuracy of the position of the image captures, while being able to use a high mast.

In particular, the significant reduction in the size of the support device allows significantly reducing the bulk of the warehouse inventory system, and therefore making the autonomous robotic device circulate in narrow aisles of the warehouse, while being able to capture images of the objects stored over the entire height of the shelves of the warehouse in one single pass.

Furthermore, the presence of the drone allows stabilizing the mast, for example in a vertical position, regardless of the fluctuations in trajectories, speeds, accelerations of the autonomous robotic device.

In addition, the fact of connecting the mast to the support device by an articulation with at least two degrees of freedom allows easily stabilizing the mast in numerous positions of the autonomous robotic device and of the support device. In particular, the presence of such an articulation allows easily stabilizing the mast even when the autonomous robotic device tilts on its roll axis, for example by rolling sideways on an inclined terrain, such as terrain inclined at 45° with respect the horizontal, or passing over a rough ground.

The presence of such an articulation also enables the drone to vertically stabilize the mast without the drone producing significant forces, which allows in particular preserving the integrity and the service life of the drone. In particular, the forces produced by the drone to compensate for the position deviations of the mast, and therefore to straighten the mast when it deviates from the vertical, are very low when a counterweight is fastened to a lower portion of the mast. On the contrary, the forces produced by a drone to compensate for the deviations in the position of the mast would be relatively large if the latter were flexible, which would require the use of a very powerful, and thus relatively expensive, drone.

Finally, the association of a rigid mast with an articulation with at least two degrees of freedom allows capturing high-precision images of the stored objects with a control of the position of each captured image (and therefore of the corresponding stored object), unlike the images that would be captured with image capturing devices arranged on a flexible mast configured to bend during the displacements of the autonomous robotic device.

The warehouse inventory system may further have one or more of the following features, considered alone or in combination.

According to an embodiment of the invention, the image capturing devices are offset with respect to each other along a longitudinal axis of the mast.

According to an alternative of the invention, the image capturing devices are substantially aligned with respect to each other.

According to an embodiment of the invention, each image capturing device includes a digital photographic camera or a digital camera.

According to an embodiment of the invention, the stored objects are products, boxes, cardboard boxed and/or pallets.

According to an embodiment of the invention, the autonomous robotic device is configured to move autonomously in the aisles of the storage area of the warehouse and along the shelves arranged in the storage area according to a predefined movement path.

According to an embodiment of the invention, the autonomous robotic device is equipped with a rechargeable battery.

According to an embodiment of the invention, the autonomous robotic device is equipped with casters configured to roll on a floor of the warehouse.

According to an embodiment of the invention, the support device is equipped with casters configured to roll on the floor of the warehouse.

According to an embodiment of the invention, the support device is a support carriage.

According to an embodiment of the invention, the at least articulation with two degrees of freedom is configured to enable a pivoting of the mast relative to the support device about a first pivot connection and about a second pivot connection substantially perpendicular to the first pivot connection.

According to an embodiment of the invention, the first and second pivot connections extend transversely, and for example perpendicularly, to a longitudinal axis of the mast.

According to an embodiment of the invention, the first and second pivot connections are configured to enable roll and pitch movements of the mast.

According to an embodiment of the invention, the articulation includes a first fastening part which is annular and which is mounted articulated on the support device about a first articulation axis, and a second fastening part which is annular and which is mounted articulated on the first fastening part about a second articulation axis, the second fastening part extending around the mast and being fastened to the mast.

According to an embodiment of the invention, the mast is configured such that the center of gravity of the mast is located substantially at the level of the articulation with at least two degrees of freedom, and for example at a height comprised between 1.5 and 2 m with respect to the ground on which the autonomous robotic device is intended to move.

According to an alternative of the invention, the articulation with at least two degrees of freedom is an articulation with three degrees of freedom, in other words a ball joint.

According to an embodiment of the invention, the stabilization device includes at least one movement sensor configured to detect the movements of the mast relative to the support device, the stabilization device being configured to control the drone according to the movements detected by the at least one movement sensor.

According to an embodiment of the invention, the stabilization device includes at least one movement sensor configured to detect movements of the mast relative to the terrestrial frame of reference, namely gravity, the stabilization device being configured to control the drone according to the movements detected by the at least one movement sensor.

According to an embodiment of the invention, the stabilization device is configured to control propellers of the drone according to the movements detected by the at least one movement sensor.

According to an embodiment of the invention, the at least one movement sensor is located in the proximity of the articulation with at least two degrees of freedom.

According to an embodiment of the invention, the stabilization device includes an inertial unit which is arranged in the proximity of the articulation with at least two degrees of freedom, the stabilization device being configured to control the drone according to the data detected by the inertial unit.

According to an embodiment of the invention, the stabilization device includes an automatic pilot (“autopilot”) which is configured to transmit control signals to the drone. Advantageously, the automatic pilot is located in the proximity of the joint with at least two degrees of freedom. For example, the control signals are defined according to the data detected by the inertial unit.

According to an embodiment of the invention, a counterweight is fastened to a lower portion of the mast, the counterweight being configured so as to place the center of gravity of a set formed by the mast and the counterweight in the proximity of the articulation with two degrees of freedom. The presence of such a counterweight allows limiting the forces to be exerted by the drone to vertically stabilize the mast, and therefore using a lower power and less expensive drone.

According to an embodiment of the invention, the mast is configured to occupy a first mast position, also called inventory position, in which the mast extends substantially vertically, and a second mast position in which the mast extends substantially horizontally. These arrangements allow facilitating the passage of the warehouse inventory system at the level of an access door of a warehouse, in particular to displace the warehouse inventory system between two contiguous warehouses, quite simply by displacing the mast in the second mast position.

According to an embodiment of the invention, the counterweight is located below the articulation with at least two degrees of freedom when the mast occupies the first mast position.

According to an embodiment of the invention, the warehouse inventory system includes a movement limiting device, also called safety device, configured to limit an amplitude of movement of the mast relative to the support device when the mast occupies the first mast position.

According to an embodiment of the invention, the movement restricting device is configured to enable a limited amplitude of movement of the mast relative to the support device, and for example about the articulation with at least two degrees of freedom, when the mast occupies the first mast position.

According to an embodiment of the invention, the movement restricting device is configured to limit an amplitude of movement of the mast about the first pivot connection, and for example of the first articulation axis, when the mast occupies the first mast position, and to limit an amplitude of movement of the mast about the second pivot connection, and for example the second articulation axis, when the mast occupies the first mast position.

According to an embodiment of the invention, the movement restricting device is configured to enable a first limited amplitude of movement of the mast about the first pivot connection, and for example about the first articulation axis, when the mast occupies the first mast position, and to enable a second amplitude of movement of the mast about the second pivot connection, and for example about the second articulation axis, when the mast occupies the first mast position.

According to an embodiment of the invention, the movement restricting device is provided on the support device.

According to an embodiment of the invention, the movement restricting device is configured to trigger an emergency stop of the warehouse inventory system.

According to an embodiment of the invention, the warehouse inventory system includes an immobilizing device configured to immobilize the mast with respect to the support device when the mast occupies the second mast position.

According to an embodiment of the invention, the mast includes a telescopic upper portion which is equipped with at least one of the image capturing devices. In particular, these arrangements allow setting the height of the mast in order to facilitate the circulation of the inventory system in aisles equipped in particular with ventilation ducts.

According to an embodiment of the invention, the telescopic upper portion is located above the drone.

According to an embodiment of the invention, the telescopic upper portion can be deployed between a deployed configuration and a retracted configuration according to a direction of deployment which is substantially parallel to the longitudinal axis of the mast.

According to an embodiment of the invention, the mast is at least partially formed by an assembly of mast sections which are removably nested into each other. These arrangements allow setting the height of the mast easily and the dismantling and simplifying the transport of the latter.

According to an embodiment of the invention, each mast section has a length comprised between 1.5 meters and 2.5 meters, and for example about 2 meters. According to an embodiment of the invention, the mast has a length larger than six meters, and for example about ten meters.

According to an embodiment of the invention, the warehouse inventory system comprises a plurality of light sources fastened to the mast, each light source being configured to illuminate objects stored on the shelves and located in a field of view of at least one image capturing device in order to improve the quality of the images captured by said image capturing device.

According to an embodiment of the invention, each light source is located in the proximity of an image capturing device.

According to an embodiment of the invention, each light source includes at least one light-emitting diode, and may for example consist of a light-emitting diode flash.

According to an embodiment of the invention, the warehouse inventory system comprises a plurality of light intensity measuring devices fastened to the mast, each light intensity measuring device being configured to measure a light intensity in the proximity of at least one image capturing device.

According to an embodiment of the invention, each light intensity measuring device is located in the proximity of an image capturing device.

According to an embodiment of the invention, the warehouse inventory system comprises a setting unit configured to set the light intensity of each light source according to the light intensity measured by at least one light intensity measuring device which is located in the proximity of said light source, and for example in the proximity of the image capturing device that is located in the proximity of said light source.

According to an embodiment of the invention, the autonomous robotic device includes exteroceptive sensors configured to detect information on an environment in which the autonomous robotic device is located.

According to an embodiment of the invention, the exteroceptive sensors include at least one LIDAR sensor.

According to an embodiment of the invention, the exteroceptive sensors are configured to detect obstacles located on the movement path of the autonomous robotic device.

According to an embodiment of the invention, the autonomous robotic device comprises a control unit which is configured to process and analyze the information detected by the exteroceptive sensors in order to identify characteristics of the environment in which the autonomous robotic device is located, and which is configured to control, in an autonomous control mode, the autonomous robotic device based on the information detected by the exteroceptive sensors.

According to an embodiment of the invention, the control unit is configured to control the autonomous robotic device from a digital plan of the warehouse (including in particular the position of the aisles of the warehouse and of the storage locations in the shelves), and so as to enable planning complete or partial inventories of the warehouse in a repeatable manner.

According to an embodiment of the invention, the warehouse inventory system comprises a processing unit configured to:
process and analyze the images captured by the image capturing devices,
detect identification codes, such as barcodes, carried by the stored objects from the captured images, and for example carried by labels arranged on the stored objects, and
identify the stored objects from the detected identification codes,
inventorize the identified objects and the storage locations of said inventoried objects in the storage area.

According to an embodiment of the invention, the processing unit is configured to generate, for each inventory, an inventory report, for example in the form of an archive.

According to an embodiment of the invention, the inventory report of each inventory includes:
the inventory time and the actual movement path of the autonomous robotic device during the inventory, and/or
the incidents encountered by the warehouse inventory system, and/or
for each detected identification code, the date and time of capture of the captured image from which the identification code was detected (for example the year, the month, the day, the hour, the minute, the second and the time zone), and/or
for each detected identification code, the location code corresponding to the storage location of the object bearing the detected identification code, and/or
for each detected identification code, the position of the identification code in the warehouse (for example the position in x, y, z of the detected identification code in meters with respect to a predefined origin of the warehouse), and/or
the number of the most relevant captured image for each detected identification code and a link to said most relevant captured image, and/or
a captured image of each storage location, whether empty or full.

According to an embodiment of the invention, each inventory report is a file in the .csv format.

According to an embodiment of the invention, the warehouse inventory system comprises an on-board computer including the processing unit.

According to an embodiment of the invention, the drone includes a central portion which is fastened to the mast, a plurality of support arms which are fastened to the central portion and which are angularly offset from each other, and a plurality of air flow generation devices which are fastened to the support arms.

According to an embodiment of the invention, the support arms extend in the same plane of extension.

According to an embodiment of the invention, each air flow generation device includes a propeller. Advantageously, the axis of rotation of each propeller is substantially parallel to the direction of extension of the respective support arm.

According to an embodiment of the invention, each air flow generation device includes a drive motor configured to drive the respective propeller in rotation.

According to an embodiment of the invention, the support device is configured to be at least partially supported by the autonomous robotic device.

According to an embodiment of the invention, the support device is configured to be towed by the autonomous robotic device.

According to an embodiment of the invention, the support device is configured to be pushed by the autonomous robotic device.

### BRIEF DESCRIPTION OF THE DRAWINGS

Anyway, the invention will be well understood from the following description with reference to the appended schematic drawings representing, as a non-limiting example, an embodiment of this warehouse inventory system.

FIG. 1 is a perspective view of a warehouse inventory system according to the invention.

FIG. 2 is a partial perspective view of a lower portion of the warehouse inventory system of FIG. 1.

FIG. 3 is a partial perspective view of a stabilization device of the warehouse inventory system of FIG. 1.

FIG. 4 is a partial perspective view of a mast of the warehouse inventory system of FIG. 1.

FIG. 5 is a perspective view of the articulation with two degrees of freedom of the warehouse inventory system of FIG. 1.

FIG. 6 is a partial perspective view of the warehouse inventory system of FIG. 1 showing the mast in the second mast position.

FIG. 7 is a front view of a shelf arranged in a storage area of a warehouse and on which objects are stored.

FIG. 8 is a perspective view of a telescopic upper portion of the warehouse inventory system of FIG. 1, showing the telescopic upper portion in a retracted configuration.

FIG. 9 is a perspective view of the telescopic upper portion of FIG. 8 in an intermediate configuration.

FIG. 10 is a perspective view of the telescopic upper portion of FIG. 8 in a deployed configuration.

### DETAILED DESCRIPTION

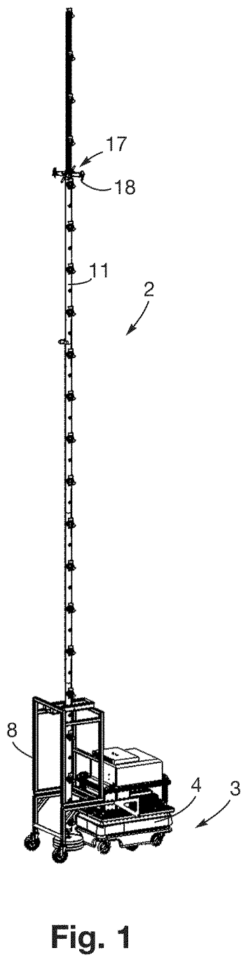

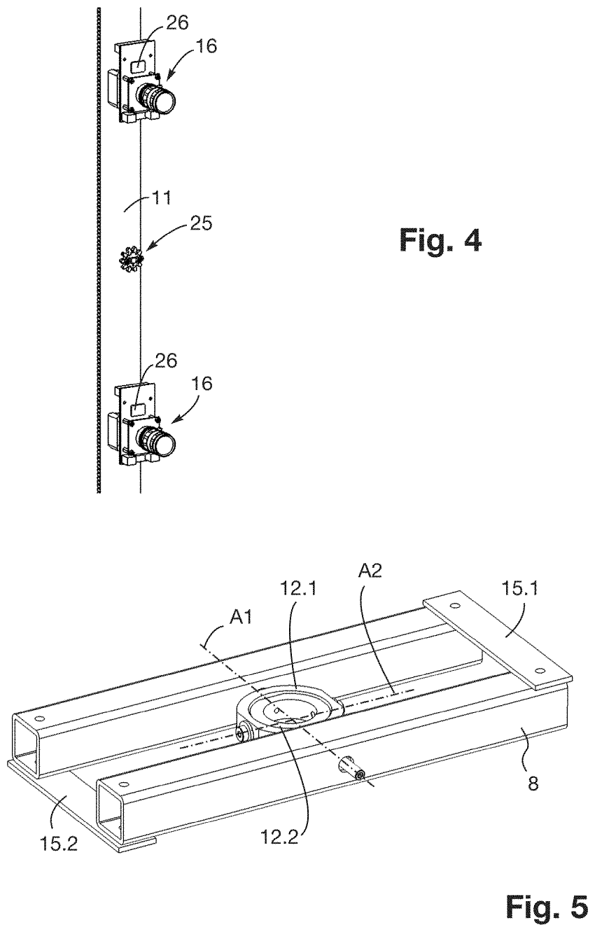

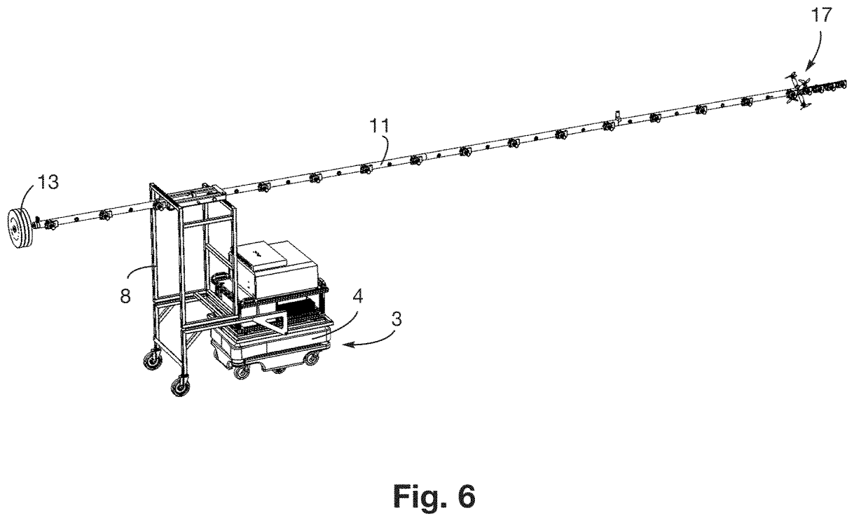

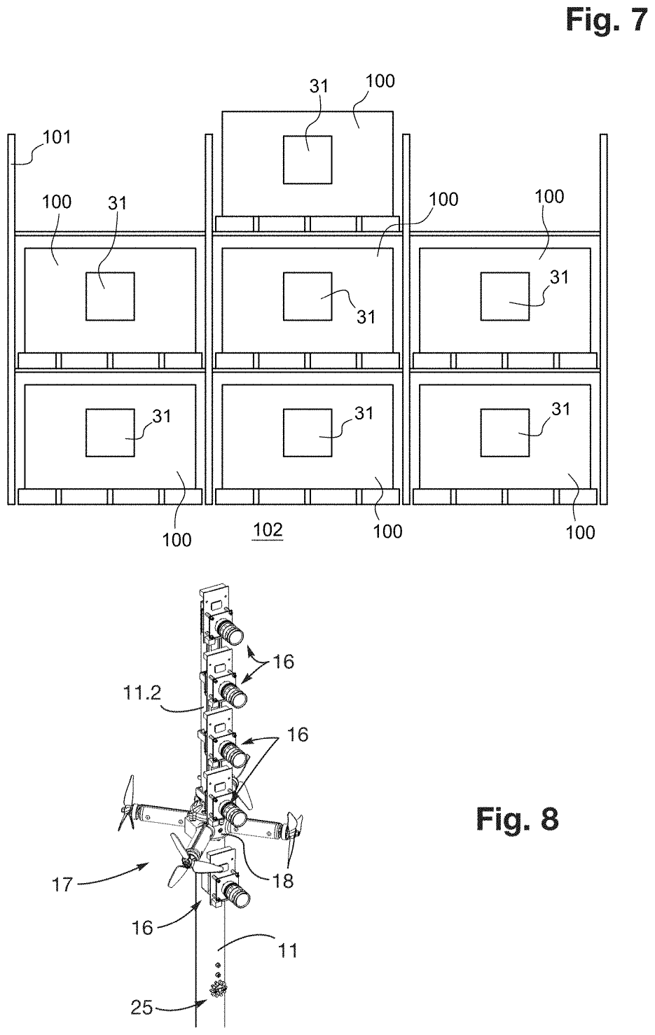

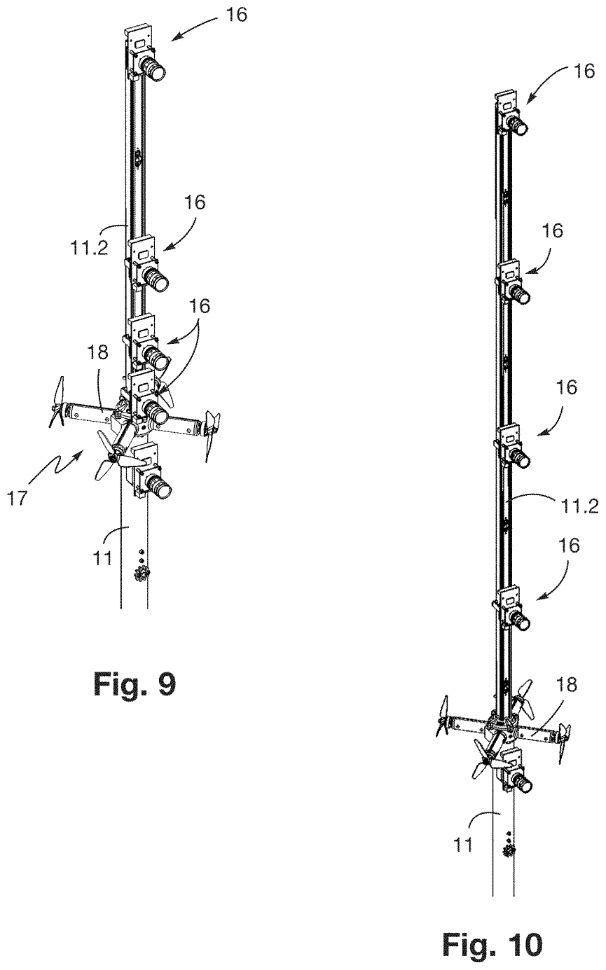

FIGS. 1 to 10 represent a warehouse inventory system 2 for carrying out an inventory of objects 100, such as products, boxes, cardboard boxes and/or pallets, stored on shelves 101 arranged in a storage area 102 of a warehouse.

The warehouse inventory system 2 includes an autonomous robotic device 3 configured to move autonomously in aisles of the storage area 102 of the warehouse and along the shelves 101 arranged in the storage area 102 according to a predefined movement path.

The autonomous robotic device 3 includes a support frame 4 including casters 5 configured to roll on a floor of the warehouse.

The autonomous robotic device 3 further includes exteroceptive sensors 6 fastened on the support frame 4 and configured to detect information on the environment in which the autonomous robotic device 3 is located. For example, the exteroceptive sensors 6 may include one or several LiDAR sensor(s), and are in particular configured to detect obstacles located on the movement path of the autonomous robotic device 3.

The autonomous robotic device 3 further comprises a control unit 7, formed for example by an electronic microcontroller, which is configured to process and analyze the information detected by the exteroceptive sensors 6 in order to identify characteristics of the environment in which the autonomous robotic device 3 is located, and which is also configured to control, in an autonomous control mode, the autonomous robotic device 3 based on the information detected by the exteroceptive sensors 6 and a digital map of the warehouse (including in particular the position of the aisles of the warehouse and of the storage locations in the shelves arranged in the storage area).

Advantageously, the autonomous robotic device 3 includes a rechargeable battery (not shown in the figures) configured to electrically power the autonomous robotic device 3.

The warehouse inventory system 2 also includes a support device 8, such as a support carriage, which is integral in movement with the autonomous robotic device 3, and which is for example fastened to the support frame 4 of the autonomous robotic device 3.

According to the embodiment represented in FIGS. 1 to 10, the support device 8 is equipped with casters 9 configured to roll on the floor of the warehouse.

The warehouse inventory system 2 further includes a mast 11 which is supported by the support device 8. The mast 11 advantageously has a length larger than six meters, and may for example reach about ten meters.

Advantageously, the mast 11 may be at least partially formed by an assembly of mast sections which are removably nested into each other. For example, each mast section has a length comprised between 1.5 meters and 2.5 meters, and for example about 2 meters.

More particularly, the mast 11 is connected to the support device 8 by an articulation 12 with two degrees of freedom which is configured to enable a pivoting of the mast 11 relative to the support device 8 about a first articulation axis A1 and about a second articulation axis A2 which is perpendicular to the first articulation axis A1. Advantageously, the first and second articulation axes A1, A2 extend perpendicularly to a longitudinal axis B of the mast 11, and are configured to enable roll and pitch movements of the mast 11. For example, the articulation 12 could be located at a height comprised between 1.5 m and 2 m relative to the ground on which the autonomous robotic device 3 is intended to move.

As shown in FIG. 5, the articulation 12 includes a first fastening part 12.1 which is annular and which is mounted articulated on the support device 8 about the first articulation axis A1, and a second fastening part 12.2 which is annular and surrounded by the first fastening part 12.1 and which is mounted articulated on the first fastening part 12.1 about the second articulation axis A2. The second fastening part 12.2 extends about the mast 11 and is fastened to the mast 11. Advantageously, the first and second fastening parts 12.1. 12.2 extend coaxially when the mast 11 extends vertically.

As shown in FIGS. 1, 2 and 6, the mast 11 is configured to occupy a first mast position, also called inventory position, in which the mast 11 extends substantially vertically, and a second mast position in which the mast extends horizontally.

The warehouse inventory system 2 further includes a counterweight 13 which is fastened to a lower portion 11.1 of the mast 11. Advantageously, the counterweight 13 is located below the articulation 12 when the mast 11 occupies the first mast position, and the mast 11 is configured such that the center of gravity of the mast 11 is located substantially at the level of the articulation 12.

The warehouse inventory system 2 includes a movement restricting device 14 configured to limit an amplitude of movement of the mast 11 about the first articulation axis A1 when the mast 11 occupies the first mast position, and to limit an amplitude of movement of the mast 11 about the second articulation axis A2 when the mast 11 occupies the first mast position. Advantageously, the movement restricting device 14 is provided on the support device 8.

According to the embodiment represented in FIGS. 1 to 10, the movement restricting device 14 includes a rear stop member 14.1 removably fastened to the support device 8 and against which a lower portion of the mast 11 could abut when the mast 11 is pivoted about the first articulation axis A1 such that the lower portion of the mast 11 is away from the autonomous robotic device 3.

The movement restricting device 14 further includes two lateral stop members 14.2 provided on the support device 8 and against each of which the lower portion of the mast 11 can abut when the mast 11 is pivoted about the second articulation axis A2.

The warehouse inventory system 2 further includes an immobilization device 15 configured to immobilize the mast 11 with respect to the support device 8 when the mast 11 occupies the second mast position.

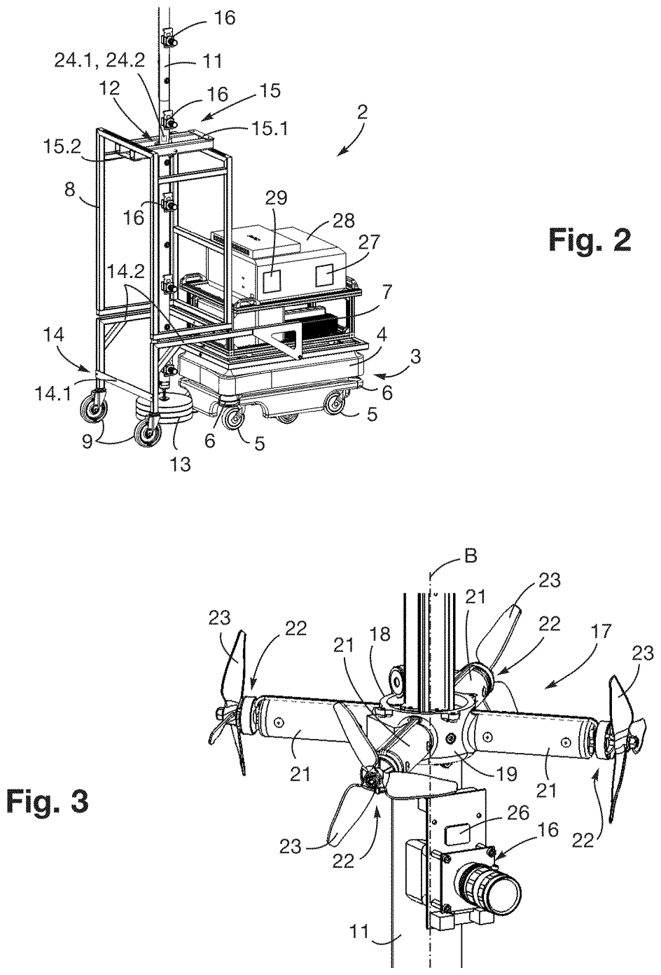

As shown more particularly in FIG. 2, the immobilization device 15 includes a first immobilization member 15.1 removably fastened to the support device 8 and a second immobilization member 15.2 also removably fastened to the support device 8. The first and second immobilization members 15.1, 15.2 are configured to extend on either side of the mast 11 when the mast 11 is in the second mast position, so as to prevent any pivoting of the mast 11 about the second articulation axis A2. According to the embodiment represented in the figures, the first and second immobilization members 15.1, 15.2 extend substantially parallel to the first articulation axis A1, and are vertically offset with respect to each other.

In order to immobilize the mast 11 in the second mast position, all it needs is to dismantle, and for example to unscrew, the first and second immobilization members 15.1, 15.2, to pivot the mast 11 around the first articulation axis A1 until positioning the mast 11 in the second mast position, and finally to fasten the first and second immobilization members 15.1, 15.2 again to the support device 8. The warehouse inventory system 2 further includes image capturing devices 16 which are fastened to the mast 11 and which are configured to capture images of the objects 100 stored on the shelves 101 during the displacements of the autonomous robotic device 3 along the shelves 101 arranged in the storage area 102.

Advantageously, the image capturing devices 16 are offset with respect to each other along the longitudinal axis B of the mast 11, and are aligned with respect to each other along the longitudinal axis B of the mast 11. For example, each image capturing device 16 may include a digital photographic camera or a digital camera.

The warehouse inventory system 2 further includes a stabilization device 17 configured to vertically stabilize the mast 11 during the displacements of the autonomous robotic device 3. The stabilization device 17 advantageously includes a drone 18 which is fastened to the mast 11, and for example to an upper portion of the mast 11.

As shown more particularly in FIG. 3, the drone 18 includes in particular a central portion 19 which is fastened to the mast 11, a plurality of support arms 21 which are fastened to the central portion 19 and which are angularly offset from each other, and a plurality of air flow generating devices 22 each being fastened to a respective support arm 21.

According to the embodiment represented in FIGS. 1 to 10, the support arms 21 extend in the same plane of extension, and each air flow generation device 22 includes a propeller 23 having an axis of rotation which is substantially parallel to the direction of extension of the respective support arm 21, and a drive motor (not shown in the figures) configured to drive the respective propeller 23 in rotation. Advantageously, the axis of rotation of each propeller 23 extends substantially radially with respect to the longitudinal axis of the mast 11.

For example, each support arm 21 may be hollow so as to enable the passage of electric power supply cables configured to electrically power the respective air flow generation device, and the reception of the respective drive motor.

The stabilization device 17 further includes an inertial unit 24.1 including at least one movement sensor configured to detect movements of the mast 11 relative to the terrestrial frame of reference, namely gravity. More particularly, the stabilization device 17 is configured to control the propellers 23 of the drone 18 according to the data detected by the inertial unit, and in particular according to the movements detected by the movement sensor.

Advantageously, the inertial unit 24.1 is located in the proximity of the articulation 12. Such a positioning of the inertial unit 24.1 enables the stabilization device 17 to be more sensitive to the displacements of the mast 11, and therefore to ensure an optimum control of the propellers 23, which allows ensuring an optimum stabilization of the mast 11. For example, the inertial unit 24.1 may be fastened to the mast 11.

The stabilization device 17 further includes an automatic pilot 24.2 which is also located in the proximity of the articulation 12 and which is configured to transmit control signals to the drone 18. The control signals are advantageously defined in particular according to the data detected by the inertial unit 24.1.

The warehouse inventory system 2 also comprises a plurality of light sources 25 fastened to the mast 11. Advantageously, the light sources 25 are offset with respect to each other along the longitudinal axis B of the mast 11, and are aligned with respect to each other along the longitudinal axis B of the mast 11. Each light source 25 may include at least one light-emitting diode, and may for example consist of a light-emitting diode flash.

Advantageously, each light source 25 is located in the proximity of an image capturing device 16 and is configured to illuminate objects 100 stored on the shelves 101 and located in a field of view of the respective image capturing device 16 in order to improve the quality of the images captured by said image capturing device 16, in particular when the objects 100 are stored in the lower portion of the shelves 101, that is to say away from the lights of the warehouse or skylights of the warehouse. According to an embodiment of the invention, each light source 25 could be located between two adjacent image capturing devices 16, and be configured to illuminate objects located in the fields of view of the adjacent image capturing devices 16.

The warehouse inventory system 2 further comprises a plurality of light intensity measuring devices 26 fastened to the mast 11. Advantageously, the light intensity measuring devices 26 are offset with respect to each other along the longitudinal axis B of the mast 11, and are aligned with respect to each other along the longitudinal axis B of the mast 11.

Each light intensity measuring device 26 is located in the proximity of an image capturing device 16 and is configured to measure a light intensity in the proximity of the respective image capturing device 16.

The warehouse inventory system 2 further comprises a setting unit 27 configured to set the light intensity of each light source 25 according to the light intensity measured by the light intensity measuring device 26 which is located in the proximity of the image capturing device 16 associated with said light source 25. These arrangements allow improving the quality of the images captured by each image capturing device 16, while limiting the electrical consumption of the inventory system 2, since it is not necessary to electrically power some light sources. 25 when the light intensity at the level of these light sources 25 is enough.

The warehouse inventory system 2 comprises an on-board computer 28, for example fastened to the support device 8, which comprises the setting unit 27 and a processing unit 29. The processing unit 29 is configured to:
process and analyze the images captured by the image capturing devices 16,
detect identification codes 31, such as barcodes, carried by the stored objects 100 from the captured images, the identification codes 31 being possibly carried by labels glued on the stored objects,
identify the stored objects 100 from the detected identification codes 31,
inventorize the identified objects and the storage locations of said inventoried objects in the storage area 102.

Such a processing unit 29 is well known to those skilled in the art, and is not therefore described in detail in the present description.

Advantageously, the processing unit 29 is further configured to generate, for each inventory, an inventory report, for example in the .csv format, including:
the inventory time and the actual movement path of the autonomous robotic device 3 during the inventory,
the incidents encountered by the warehouse inventory system 2,
for each detected identification code 31, the date and time of capture of the captured image from which the identification code 31 was detected (for example the year, the month, the day, the hour, the minute, the second and the time zone),
for each detected identification code 31, the location code corresponding to the storage location of the object bearing the detected identification code 31,
for each detected identification code 31, the position of the identification code 31 in the warehouse (for example the position in x, y, z of the detected identification code in meters with respect to a predefined origin of the warehouse),
the number of the most relevant captured image for each detected identification code 31 and a link to said most relevant captured image, and
a captured image of each storage location of each shelf 101 of the warehouse, whether empty or full.

As shown in FIGS. 8 to 10, the mast 11 further includes a telescopic upper portion 11.2 which is located above the drone 18, and which is fastened to the central portion 19 of the drone 18. Advantageously, the telescopic upper portion 11.2 extends parallel to the main portion of the mast 11 and is equipped with several image capturing devices 16.

The telescopic upper portion 11.2 of the mast is deployable between a deployed configuration (cf. FIG. 10) in which the image capturing devices 16 carried by the telescopic upper portion 11.2 are away from each other and a retracted configuration (cf. FIG. 8) in which the image capturing devices 16 carried by the telescopic upper portion 11.2 are brought close to each other. Advantageously, the warehouse inventory system 2 includes drive means configured to displace the telescopic upper portion 11.2 between the deployed and retracted configurations.

It goes without saying that the invention is not limited to the sole embodiment of this warehouse inventory system, described hereinabove as example, it encompasses on the contrary all variants thereof. Thus, in particular, the articulation 12 could be an articulation with three degrees of freedom, in other words a ball joint.

1. A warehouse inventory system for carrying out an inventory of objects stored on shelves arranged in a storage area of a warehouse, the warehouse inventory system including:
an autonomous robotic device configured to move autonomously in aisles of the storage area of the warehouse and along shelves arranged in the storage area;
a support device integral in movement with the autonomous robotic device;
a mast which is supported by the support device and which is equipped with image capturing devices configured to capture images of the objects stored on the shelves during displacements of the autonomous robotic device along the shelves arranged in the storage area, the mast being connected to the support device by an articulation with at least two degrees of freedom; and
a stabilization device configured to vertically stabilize the mast during the displacements of the autonomous robotic device, the stabilization device including a drone connected to the mast.

2. The warehouse inventory system according to claim 1, wherein the at least articulation with two degrees of freedom is configured to enable a pivoting of the mast relative to the support device about a first pivot connection and about a second pivot connection substantially perpendicular to the first pivot connection.

3. The warehouse inventory system according to claim 2, wherein the first and second pivot connections extend transversely to a longitudinal axis of the mast.

4. The warehouse inventory system according to claim 1, wherein the stabilization device includes at least one movement sensor configured to detect movements of the mast relative to a terrestrial frame of reference, the stabilization device being configured to control the drone according to the movements detected by the at least one movement sensor.

5. The warehouse inventory system according to claim 1, wherein a counterweight is fastened to a lower portion of the mast, the counterweight being configured so as to place a center of gravity of an assembly formed by the mast and the counterweight in proximity of the articulation with two degrees of freedom.

6. The warehouse inventory system according to claim 1, wherein the mast is configured to occupy a first mast position in which the mast extends substantially vertically, and a second mast position in which the mast extends substantially horizontally.

7. The warehouse inventory system according to claim 6, further including a movement limiting device configured to limit an amplitude of movement of the mast relative to the support device when the mast occupies the first mast position.

8. The warehouse inventory system according to claim 6, further including an immobilizing device configured to immobilize the mast with respect to the support device when the mast occupies the second mast position.

9. The warehouse inventory system according to claim 1, wherein the mast includes a telescopic upper portion which is equipped with at least one of the image capturing devices.

10. The warehouse inventory system according to claim 9, wherein the telescopic upper portion is located above the drone.

11. The warehouse inventory system according to claim 1, wherein the mast is at least partially formed by an assembly of mast sections which are removably nested into each other.

12. The warehouse inventory system according to claim 1, further comprising a plurality of light sources fastened to the mast, each light source being configured to illuminate objects stored on the shelves and located in a field of view of at least one image capturing device.

13. The warehouse inventory system according to claim 1, further comprising a plurality of light intensity measuring devices fastened to the mast, each light intensity measuring device being configured to measure a light intensity in proximity of at least one image capturing device.

14. The warehouse inventory system according to claim 12, further comprising a setting unit configured to set a light intensity of each light source according to a light intensity measured by at least one light intensity measuring device which is located in proximity of said light source.

15. The warehouse inventory system according to claim 3, wherein the stabilization device includes at least one movement sensor configured to detect movements of the mast relative to a terrestrial frame of reference, the stabilization device being configured to control the drone according to the movements detected by the at least one movement sensor.

16. The warehouse inventory system according to claim 15, wherein a counterweight is fastened to a lower portion of the mast, the counterweight being configured so as to place a center of gravity of an assembly formed by the mast and the counterweight in proximity of the articulation with two degrees of freedom.

17. The warehouse inventory system according to claim 16, wherein the mast is configured to occupy a first mast position in which the mast extends substantially vertically, and a second mast position in which the mast extends substantially horizontally.

18. The warehouse inventory system according to claim 17, further including a movement limiting device configured to limit an amplitude of movement of the mast relative to the support device when the mast occupies the first mast position.

19. The warehouse inventory system according to claim 18, further including an immobilizing device configured to immobilize the mast with respect to the support device when the mast occupies the second mast position.

20. The warehouse inventory system according to claim 19, wherein the mast includes a telescopic upper portion which is equipped with at least one of the image capturing devices.
